(19) United States
(12) Patent Application Publication
(10) Pub. No.: US 2009/0022863 A1
(43) Pub. Date: Jan. 22, 2009

(54) Method of Packing a Food and of Heat Treating It for Purposes of Extending Its Shelf-Life

(75) Inventors: Jan Lagerstedt, Malmo (SE); Bengt Andersson, Malmo (SE)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (CH)

(21) Appl. No.: 12/223,776

(22) PCT Filed: Feb. 9, 2007
(86) PCT No.: PCT/SE2007/000116

§ 371 Date: Aug. 8, 2008

(30) Foreign Application Priority Data
Mar. 21, 2006 (SE) 0600650-6

(51) Int. Cl. A23L 1/025; A23L 3/36

(52) U.S. Cl. 426/393; 426/392

(57) ABSTRACT

A method of packing a food, and heat treating the food for purposes of extending its shelf-life, in a packaging container made of a packaging laminate comprising a core layer of paper or paperboard and outer plastic coatings of polyethylene, preferably low density polyethylene. The filled and sealed packaging container is conveyed through a treatment chamber or tunnel comprising a heating zone in which the packaging container is heated to the desired treatment temperature, e.g. 80-100° C., a holding zone in which the packaging container is kept at the desired treatment temperature and a cooling zone, wherein the packaging container during both of these treatment phases is subjected to an outer support pressure of less than 0.5 bar, preferably 0.2-0.3 bar.

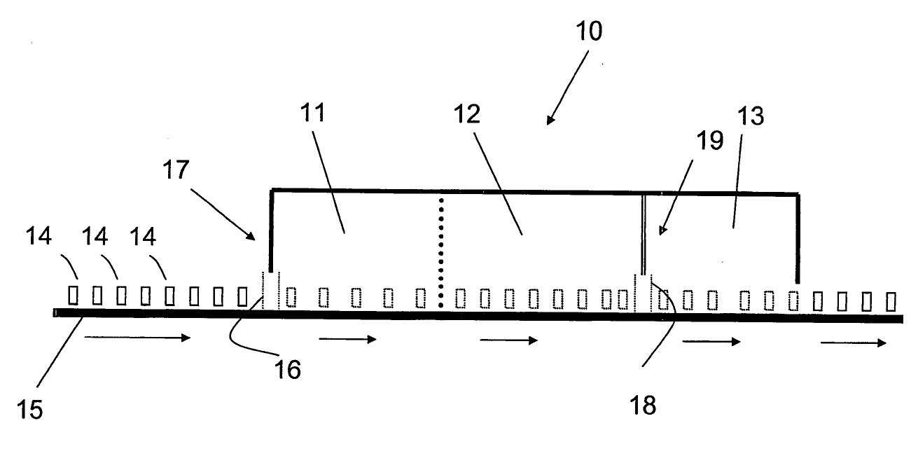

### TECHNICAL FIELD

The present invention relates to a method of packing, and heat treating for purposes of extending its shelf-life, a food in a packaging container consisting of a packaging laminate comprising a core layer of paper or paperboard and outer layers of polyethylene, in which method the food is filled into the open packaging container which is thereafter closed and sealed and fed through the inlet into a treatment chamber or tunnel provided with an inlet and outlet, in which treatment chamber or tunnel the packaging container is conveyed in sequence through a heating zone in which the food is heated to a desired treatment temperature, a holding zone in which the food is kept at the desired treatment temperature for a sufficient period of time to exterminate, deactivate or eliminate undesirable microorganisms, and a cooling zone in which the food is cooled, whereafter the packaging container is removed from the treatment chamber or the tunnel through the outlet for further transport and handling.

One method of the type described by way of introduction is previously known from Swedish Patent Application number 0500906-3, filed on 19 Apr. 2005.

### BACKGROUND ART

In the method according to the above-mentioned Swedish patent application, the food is filled into the open packaging container which is thereafter closed and sealed. The sealed packaging container is fed in through the inlet in a treatment chamber or tunnel provided with an inlet and outlet, in which treatment chamber or tunnel the packaging container is, in sequence, conveyed through a heating zone, a holding zone and a cooling zone.

In the heating zone, the packed food is heated to a temperature of between 80 and 100° C. by means of the supply of a heating medium, preferably a gaseous heating medium, e.g. steam. When the temperature in the food has reached the desired temperature within the above mentioned temperature range, the packaging container is conveyed further into the holding zone.

In the holding zone, the temperature in the packed food is kept at 80-100° C. during a sufficient predetermined period of time, normally from a few minutes up to 30 minutes, preferably 10-30 minutes, by means of the continued supply of gaseous heating medium, e.g. steam. After holding at a temperature of 80-100° C. during the predetermined period of time, the packaging container is conveyed further into a cooling zone.

In the cooling zone, the packaging container is cooled by means of a cooling agent, preferably cold water, which is sprayed in finely-divided form against the outsides of the packaging container until the temperature in the packed food has fallen to the desired temperature, whereafter the cooled packaging container is removed from the treatment chamber or tunnel through the outlet for further transport and handling.

One serious drawback inherent in the prior art method is that it requires a separate heating of the food, or at least a part thereof, prior to filling into the packaging container. The reason for this is that a filling of the food at a temperature below 80-100° C. would require an excessively long stay-time in the treatment chamber or tunnel so as to heat the food to the desired heat treatment temperature (i.e. 80-100° C.) by means of gaseous heating medium, because of the relatively low thermal transfer capacity of the gaseous heating medium. An excessively long stay-time in the treatment chamber or tunnel would render the method uneconomical and unprofitable and as a result unattractive for use on a rational industrial scale.

A separate preceding heat treatment of the food, as proposed in the above-mentioned Swedish patent application, may moreover on many occasions be actually harmful to the food, since a heat treatment often subjects particularly sensitive foods or parts of such foods to both thermal and mechanical stresses which have a negative effect on the properties of the food. Examples of particularly sensitive foods which are negatively affected by such heat treatment are diced tomatoes, green olives, raspberries and blackberries, as well as fruit in general, for example pineapple, apple, citrus fruits, pears etc.

Thus, there is still a need in the art for a method of packing a food and heat treating it for purposes of extending its shelf-life which neither requires any separate preceding heat treatment of the food or parts thereof and which nevertheless can be put into effect without excessively long stay-times in the treatment chamber or the tunnel.

### OBJECTS OF THE INVENTION

Thus, the task forming the basis of the present invention is to satisfy the above-mentioned need.

One object of the present invention is, hence, to provide a method of the type described by way of introduction by means of which the above-discussed drawbacks in the prior art method are obviated.

A further object of the present invention is to realise a method by means of which a food may effectively and rationally be packed and heat treated for purposes of extending its shelf-life in a packaging container of paper or paperboard and plastic, without the requirement that the food or any part thereof be subjected to a separate heat treatment prior to the filling and heat treatment in the packaging container.

Yet a further object of the present invention is to realise a method of packing a food and heat treating it with a view to extending its shelf-life, in which method the relevant food may be filled into the packaging container at a temperature below 80° C., preferably already at ambient temperature or even lower, without the need to delay or extend the stay-time for the packed food in the above mentioned treatment chamber or tunnel.

One specific object of the present invention is to realise a method of packing and heat treating for purposes of extending the shelf-life of particularly heat-sensitive foods of the type mentioned above in a packaging container without the risk that the food be exposed to thermal and/or mechanical stresses which have an injurious effect on quality, as in the prior art method.

These and other objects and advantages will be attained according to the present invention by means of a method displaying the characterising features as set forth in appended claim 1.

Expedient embodiments of the method according to the present invention have further been given the characterising features as set forth in the appended subclaims.

### BRIEF SUMMARY OF THE INVENTION

Thus, the present invention realises a method of packing a food and heat treating it for purposes of extending its shelf-life, in a packaging container consisting of a packaging laminate comprising a core layer of paper or paperboard and outer layers of polyethylene, in which method the food is filled into the open packaging container which is thereafter closed and sealed and fed in through the inlet of a treatment chamber or tunnel provided with an inlet and outlet, in which treatment chamber or tunnel the packaging container is conveyed in sequence through a heating zone in which the packaging container is heated to a predetermined temperature, a holding zone in which the packaging container is kept at the predetermined temperature during a sufficient period of time to exterminate, deactivate or otherwise eliminate undesirable microorganisms in the food, and a cooling zone in which the packaging container is cooled, whereafter the cooled packaging container is removed from the treatment chamber or tunnel through the outlet for further transport and handling. The method is characterised in that the packaging container, in both the heating zone and in the holding zone, is heated by means of a liquid heating medium, and that the packaging container, throughout the entire passage through the heating zone and the holding zone, is subjected to an outer support pressure.

By the combination of liquid heating medium, which possesses a much more efficient thermal transfer capacity than a gaseous heating medium, and outer support pressure so as to prevent deformation of the packaging container arising out of an expanding entrapped air volume in the packaging container, the method according to the present invention may be carried out on a rational, industrial scale without any requirements on preceding heat treatment of the food, and thus without the risk of deterioration of the quality of the food because of thermal and/or mechanical outer stresses. In particular, the method according to the present invention may be carried into effect substantially without any negative effects on the pristine qualities of the packed food even if the food is particularly heat sensitive and is of the type mentioned above, i.e. diced tomatoes, green olives, raspberries and blackberries, as well as fruit in general, for example pineapple, apple, citrus fruits, pears etc.

The liquid heating medium may be any liquid heating medium whatever, but is preferably hot water which is sprayed or showered in finely-divided form on the outer walls of the packaging container in order to heat the packed food from filling temperature to the desired treatment temperature (80-100° C.) and keep the food at this treatment temperature (80-100° C.) during the passage of the packaging container through the heating zone and holding zone, respectively, in the treatment chamber or tunnel.

The support pressure against the outer walls of the packaging container during both the heating and the holding stages in the treatment chamber or tunnel may be provided by means of suitable sluice devices at the inlet to the heating zone and at the transition from the holding zone to the cooling zone, between which sluice devices an excess pressure may be created and maintained within the heating zone and the holding zone during the passage of the packaging container through both of these zones. According to the present invention, the support pressure should be sufficiently elevated to prevent the packaging container from being deformed or damaged in any other way, for example a ruptured sealing joint, because of the entrapped expanding gas volume inside the packaging container, but should preferably be lower than the prescribed lowest pressure limit for so-called pressure vessels in order to make for the use of constructionally simpler and more economical apparatuses which are not classified as pressure vessels and are therefore not covered by the prescribed pressure vessel standards. In practice, the support pressure in the method according to the present invention should not, therefore, be greater than 0.5 bar (the lower limit for pressure vessels). Preferably, the support pressure is between 0.2 and 0.3 bar.

The choice of support pressure depends substantially on the amount of air which is entrapped in the packaging container, the support pressure increasing with increasing entrapped air quantity. Since the total entrapped air quantity is equal to the total of the air quantity in the unfilled upper region of the interior of the packaging container (“the headspace”) and the air quantity which accompanies the food into the packaging container and is released from the food during the heating and -holding phases, at a given “headspace”, a higher support pressure should be selected in those cases where the relevant food consists exclusively of particles, e.g. slices or dices of meat or fruit, or a combination of such particles and liquid, e.g. cooking juice, stock, fruit juice, than in those cases where the food consists exclusively of liquid. Correspondingly, the support pressure which is to be selected may depend on the filling temperature of the relevant food, in which event lower filling temperatures may require higher support pressure than higher filling temperatures, because of the fact that the quantity of air which accompanies the food has had time to be released from the food at a rate which increases with increasing filling temperature, whereby the total entrapped air quantity in the packaging container is to all essentials determined by and is equal to the unfilled upper region of the interior of the packaging container (“the headspace”). However, the selected support pressure need not in any case be greater than 0.5 bar in order to effectively prevent deformation or other damage, e.g. ruptured sealing joint, because the inner excess pressure built up in the packaging container during the heating and/or holding in the treatment chamber or tunnel.

On reducing the method according to the present invention into practice, the packaging container is produced from a packaging laminate comprising a core layer of paper or paperboard and outer layers of plastic on both sides of the core layer. As outer plastic layer, use is made of polyethylene, preferably low density polyethylene, which a readily available cost-effective plastic which makes for mechanically strong sealing joints between opposing plastic layers by thermosealing during the packaging production.

In order to impart to the packaging container requisite tightness properties against gases, in particular oxygen gas, the packaging laminate is supplemented with a layer of aluminium (Alifoil) between the core layer and the outer plastic layer which is intended to be turned to face inwards in the packaging container. In certain cases, in particular when the packaging container is intended to be filled with a particularly oxygen gas-sensitive food, it may be necessary to provide the packaging laminate with an additional layer of a material possessing superior gas barrier properties in order to compensate for leakages in the Alifoil of the packaging laminate because of cracks which may occur during reforming of the packaging laminate into packaging containers. Examples of such materials for the additional layer may be polyethylene terephthalate (PET), amorphous polyethylene terephthalate (APET), cyclic olefin copolymers (COC), nylon, polyamide (PA), amorphous polyamide (APA), liquid crystalline polymers (LCP), ethylene vinyl alcohol (EVOP), silicon dioxide (SiOx) and polyvinyl alcohol (PVOH). The present invention is not restricted exclusively to these listed barrier materials, but other materials possessing barrier properties known to a person skilled in the art may also be employed. Preferably, such a compensatory extra barrier layer is placed between the core layer of the packaging laminate and said Alifoil.

In one practical embodiment, the packaging container may, in the method according to the present invention, be produced from a packaging laminate of the following composition, counting from the outside of the packaging container and inwards: PE/printed decorative artwork/paper or paperboard/lamination layer/Alifoil/adhesive/ PE.

In another practical embodiment, the packaging container may be produced from a packaging laminate which has the composition, counting from the outside of the packaging container and inwards:

Lacquer/printed decorative artwork/PE/paper or paperboard/lamination layer/Alifoil/adhesive/PE.

According to one aspect of the present invention, the one outer plastic layer of the packaging laminate (that plastic layer which is intended to be turned to face inwards in the packaging container in contact with the contents of the packaging container) has a thickness of 20-60 μm, preferably 25-40 μm. The other plastic layer of the packaging laminate (that plastic layer which is intended to form the outside of the packaging container) has a thickness of 12-50 μm, preferably 20-40 μm.

A packaging container for use in the method according to the present invention may be produced from a sheet- or web-shaped blank of the packaging laminate according a conventional forming/filling/sealing technique. From, for example, a sheet-shaped blank, the packaging container is produced in that the blank is first reformed into an open tubular packaging carton by both longitudinal edges of the blank being united to one another in an overlap joint or seam by thermosealing. The one open end of the carton is closed by fold formation and sealing of the continuous foldable bottom panels of the blank, whereafter the carton is filled with the pertinent product through the open top end of the carton. After filling, the top end of the carton is closed by fold formation and sealing of the corresponding foldable top panels of the blank for the formation of the finished, filled packaging container which displays a normally parallelepipedic geometric configuration.

In the method according to the present invention, the packaging container may be filled with both hot and cold product, even if the filling of particularly sensitive products, as was mentioned previously, is preferably carried out without any preceding heat treatment of the product. Whether the packaging container is filled with hot or cold product, the packaging container, or a group of packaging containers, is advanced through the inlet into a treatment chamber or tunnel provided with inlet and outlet and through which the packaging container or group of packaging containers, respectively, is conveyed in sequence through a heating zone, a holding zone and a cooling zone before removal through the outlet for further transport and handling.

According to the present invention, the treatment chamber may be a continuously operating tunnel including one or more endless conveyor belts with the aid of which the filled packaging containers are conveyed in sequence through the above described treatment zones. If several conveyor belts are utilised, these may be placed parallel with one another and/or over one another.

According to another embodiment of the present invention, the treatment chamber may be formed as a continuously operating tunnel including a through-going path along which carriages filled with packaging containers are transported in sequence through the above mentioned treatment zones.

According to yet a further embodiment, the treatment chamber may be provided with a helical path along which packaging containers are conveyed upwards and/or downwards during the heat treatment. Preferably, the packaging containers are first conveyed upwards along a helical path section and then downwards along a subsequent helical path section.

Whether the treatment chamber is designed as a continuously operating tunnel including one or more conveyor belts, or a through-going path for carriages filled with packaging containers, or a helical tunnel, the packaging containers are preferably placed in such a manner that they are located very close to one another throughout the entire stay-time inside the treatment chamber. By such means, adjacent packaging containers may be used as support to one another during the transport through the chamber or the tunnel.

### BRIEF DESCRIPTION OF THE ACCOMPANYING DRAWING

The present invention will now be described in greater detail hereinbelow, with reference to the accompanying Drawing in which the FIGURE illustrates in a schematic perspective view the principle of heat treatment of filled packaging containers in a treatment chamber or tunnel in the method according to the invention.

### DETAILED DESCRIPTION OF THE DRAWING AND PREFERRED EMBODIMENT

From sheet-shaped blanks of a packaging laminate comprising a core layer of paper or paperboard and outer plastic coatings of polyethylene on both sides of the core layer, filled packaging containers are produced with the aid of a filling machine which both forms, fills and seals finished packaging containers from the sheet-shaped blanks as described above.

The filled packaging containers are transferred from the filling machine to a treatment chamber disposed in association with the filling machine and carrying the generic reference numeral 10 and comprising a heating zone 11, a holding zone 12 and a cooling zone 13.

The packaging containers are placed in ranked groups 14 with an optional number of packages in each rank and with a short spacing between the ranks on an endless conveyor belt 15 which, via the infeed end 17 of the treatment chamber 10 provided with sluice devices 16, conveys the thus arranged packaging containers into and through the heating zone 11. During the passage through the heating zone 11, the contents in the packaging containers are heated to a desired treatment temperature, e.g. 80-100° C., by means of liquid heating medium, preferably water in droplet form, which through nozzles (not shown) along the path of movement of the conveyor belt, is sprayed or showered on the outer walls of the passing packaging containers.

When the desired treatment temperature has been reached, the packaging containers are conveyed further from the heating zone 11 into and through the holding zone 12 during continued supply of heat through corresponding nozzles disposed along the path of movement of the conveyor belt and spraying or showering liquid heating medium, preferably water, on the outer walls of the packaging containers in order to maintain the desired treatment temperature throughout the entire passage through the holding zone 12.

After the passage through the holding zone 12, the packaging containers are discharged through the discharge end 19 of the holding zone 12 provided with sluice devices 18, into and through the cooling zone 13 of the treatment chamber 10 in which the hot contents in the packaging containers are cooled with the aid of cold water which is sprayed or showered on the outer walls of the packaging containers through correspondingly directed nozzles along the path of movement of the conveyor belt through the cooling zone 13.

After the passage through the cooling zone 13, the packaging containers are removed from the treatment chamber 10 for further transport and handling.

Throughout the entire treatment phase in the heating zone 11 and in the holding zone 12, an excess pressure is maintained in both of these zones which, according to the invention, is to be sufficiently elevated to withstand and prevent deformation or other damage to the packaging containers because of expanding entrapped gas volume, but at the same time sufficiently low so as to make for use of constructionally simple apparatuses which do not need to satisfy the prescribed standards for pressure vessels. In practice, the method according to the present invention is therefore carried out at an excess pressure within the range of 0.2-0.5 bar in both of these treatment zones.

While the present invention has been described above with particular reference to a straight treatment chamber with endless conveyor belts for conveying the packaging containers therethrough, the present invention is not restricted to this particular type of treatment chamber. According to the invention, other types of treatment chambers may also be employed, for example a treatment chamber with a helical conveyor path for the packaging containers, as was described previously. The choice of treatment chamber is not critical to the present invention and, in each individual case, may be decided on, for example, by access to suitable equipment. For a person skilled in the art with the guidance of the above description, it is therefore simple to decide what type of treatment chamber or tunnel is suitable for the case in point. Further, the packaging containers need not, as in the described example, be placed directly on a conveyor belt but could just as well be placed in suitable groups or stacks on one another, such as on different shelves in a shelved carriage. All such modifications obvious to a person skilled in the art in the above described method according to the present invention lie within the scope of the inventive concept as this is defined in the appended Claims.

### INDUSTRIAL APPLICABILITY

The method according to the present invention is applicable for packing a food and heat treating the food for purposes of extending its shelf-life in a packaging container consisting of a packaging laminate comprising a core layer of paper or paperboard and outer plastic coatings of polyethylene, preferably low density polyethylene, on both sides of the core layer. The present invention is particularly advantageous in order, by such means, to pack and heat treat foods of a particularly heat-sensitive nature, e.g. diced tomatoes, green olives, raspberries and blackberries, as well as fruits in general, for example pineapple, apple, citrus fruits, pears etc.

1. A method of packing a food and heat treating the food for purposes of extending its shelf-life, comprising:
filling food into an open packaging container made of a packaging laminate comprising a core layer of paper or paperboard and outer layers of polyethylene;
closing and sealing the packaging container filled with food to produce a filled and sealed packaging container;
feeding the filled and sealed packaging container into a treatment chamber or tunnel provided with an inlet and outlet, in which the packaging container is conveyed in sequence through a heating zone in which the food is heated to a desired treatment temperature, a holding zone in which the food is kept at the desired treatment temperature during a sufficient period of time in order to exterminate, deactivate or otherwise eliminate undesirable microorganisms, and a cooling zone in which the food is cooled;
removing the filled and sealed packaging container from the treatment chamber or the tunnel for further transport and handling;
the filled and sealed packaging container is, in both the heating zone and in the holding zone, heated by a liquid heating medium; and
the filled and sealed packaging container is, throughout the entire transport through the heating zone and the holding zone, subjected to an outer support pressure.

2. The method as claimed in claim 1, wherein the liquid heating medium is hot water.

3. The method as claimed in claim 2, wherein the liquid heating medium is sprayed or showered in finely-divided form on the outer walls of the filled and sealed packaging container.

4. The method as claimed in claim 1, wherein the outer support pressure is kept at a level below 0.5 bar.

5. The method as claimed in claim 1, wherein the outer support pressure is kept at 0.2-0.3 bar.

6. The method as claimed in claim 1, further comprising placing a group of filled and sealed packaging containers in ranks on one or more conveyor belts, and conveying the filled and sealed packaging containers through the treatment chamber.

7. The method as claimed in claim 1, comprising conveying the filled and sealed packaging container through a treatment chamber along a helical conveyance path between its inlet and outlet.

8. The method as claimed in claim 1, further comprising filling the food into the packaging container at a temperature corresponding to or slightly lower than the desired treatment temperature.

9. The method as claimed in claim 1, further comprising filling the food into the packaging container at a temperature close to or just below 0° C.

10. The method as claimed in claim 1, wherein both the filling and the heat treatment of the food are carried out continuously by a filling machine which forms, fills and seals packaging containers and a heat treatment chamber or tunnel disposed in association with the filling machine, discharged packaging containers from the filling machine being grouped and fed groupwise in directly into the treatment chamber.
